(19) United States
(12) Patent Application Publication
(10) Pub. No.: US 2007/0097034 A1
(43) Pub. Date: May 3, 2007

(54) Plasma display device, driving apparatus and driving method thereof

(76) Inventor: Sang-Shin Kwak, Yongin-si (KR)

Correspondence Address: CHRISTIE, PARKER & HALE, LLP, PO BOX 7068, PASADENA, CA, 91109-7068, US

(21) Appl. No.: 11/585,720

(22) Filed: Oct. 23, 2006

(30) Foreign Application Priority Data
Nov. 2, 2005 (KR) 10-2005-0104207

(51) Int. Cl. G09G 3/28

(52) U.S. Cl. 345/68

(57) ABSTRACT

A plasma display device, a driving apparatus and a driving method are provided. A first transistor is coupled to a power source and electrodes of a first group. A second transistor is coupled to the power source and electrodes of a second group. A third transistor is coupled to a first diode. The fourth transistor is coupled to the electrodes of the first group and a second power source. The fifth transistor is coupled to the electrodes of the second group and the second power source. A first diode is coupled to an inductor. A second diode is coupled to the fifth transistor and the electrodes of the second group. A third diode is coupled to the electrodes of the second group and the third transistor. The fourth diode is coupled to the third transistor and the electrodes of the second group.

### CROSS-REFERENCE TO RELATED APPLICATION

This application claims priority to and the benefit of Korean Patent Application No. 10-2005-0104207 filed in the Korean Intellectual Property Office on Nov. 2, 2005, the entire content of which is incorporated herein by reference.

### BACKGROUND OF THE INVENTION

(a) Field of the Invention

The present invention relates to a plasma display device, a driving apparatus and a driving method thereof. More particularly, the present invention relates to a power recovery circuit of a plasma display device, a driving apparatus and a driving method thereof.

(b) Description of the Related Art

A plasma display device is a flat panel display that uses plasma generated by a gas discharge to display characters or images. The plasma display device is driven by a plurality of subfields of a frame. A turn-on discharge cell is selected among a plurality of discharge cells by performing an addressing discharge for an address period of each subfield, and the turn-on discharge cell is sustain-discharged for a sustain period of each field so as to display an image.

Particularly, during the sustain period, high and low level voltages are alternately applied to the electrodes for performing a sustain discharge. In this case, capacitance exists on the panel due to a discharge space between scan and sustain electrodes performing sustain discharges and the discharge space operates as a capacitive load. Accordingly, an additional reactive power as well as power for the sustain discharge is desirable so as to apply the sustain pulses of the high and low level voltages to the two electrodes. Therefore, a typical sustain discharge driving circuit includes a power recovery circuit for recovering and reusing the reactive power. The power recovery circuit typically uses additional capacitors for generally supplying and recovering energy. Therefore, the cost is increased because this power recovery capacitor has a large capacitance.

### SUMMARY OF THE INVENTION

One exemplary embodiment of the present invention provides a plasma display device that includes a plurality of electrodes grouped into a first group and a second group. The device also includes a first transistor coupled between a first power source and electrodes of the first group wherein the first power source is supplying a first voltage. The display also includes a second transistor coupled between the first power source and electrodes of the second group. The display also includes an inductor having a first end coupled to the electrodes of the first group, a first diode having an anode coupled to a second end of the inductor and a third transistor having a first end coupled to a cathode of the first diode. The display also includes a second diode having an anode coupled to a second end of the third transistor and a cathode coupled to the electrodes of the second group, a third diode having an anode coupled to the electrodes of the second group and a cathode coupled to the first end of the third transistor. The display also includes a fourth diode having an anode coupled to the second end of the third transistor and a cathode coupled to the electrodes of the second group. The display also includes a fourth transistor coupled between the electrodes of the first group and a second power source for supplying a second voltage, and a fifth transistor coupled between the electrodes of the second group and the second power source. The electrodes of the first group may include odd numbered electrodes and the electrodes of the second group may include even numbered electrodes. The plasma display device further includes: a controller adapted to set the third transistor to be turned on during a first mode; and to set the second transistor and the fourth transistor to be turned on during a second mode. The controller is also adapted to set the third transistor to be turned on during a third mode; and to set the first transistor and the fifth transistor to be turned on during a fourth mode.

Another embodiment of the present invention provides a driving method of a plasma display device having a plurality of electrodes being grouped into a first group and a second group. The driving method includes, during a first mode, applying a first voltage to electrodes of the first group and a second voltage less than the first voltage to electrodes of the second group. The method also includes, during a second mode, forming a resonance path through the electrodes of the first group, an inductor having a first end coupled to the electrodes of the first group, and a first transistor coupled between a second end of the inductor and the electrodes of the second group, and decreasing a voltage of the electrodes of the first group and increasing a voltage of the electrodes of the second group. The method also includes, during a third mode, applying the second voltage to the electrodes of the first group and applying the first voltage to the electrodes of the second group. The method also includes, during a fourth mode, forming a resonance path through the electrodes of the second group, the first transistor, the inductor and the electrodes of the first group, and increasing the voltage of the electrodes of the first group and decreasing the voltage of the electrodes of the second group.

Another embodiment of the present invention provides a driving apparatus having a plurality of electrode being grouped into a first group and a second group. The driving apparatus includes an inductor having a first end coupled to electrodes of the first group. The apparatus also includes a first path including a first transistor, wherein the first transistor is coupled between a second end of the inductor and a electrodes of the second group; and a second path including the first transistor, wherein the first transistor is coupled between the second end of the inductor and the electrodes of the second group. The apparatus also includes a second transistor coupled between the electrodes of the first group and a first power source for supplying a first voltage; and a third transistor coupled between the electrodes of the second group and the first power source. The apparatus also includes a fourth transistor coupled between the electrodes of the first group and a second power source supplying a second voltage; and a fifth transistor coupled between the electrodes of the second group and the second power source. The first path may further include: a first diode having an anode coupled to the second end of the inductor and an cathode coupled to the first end of the first transistor; and a second diode having an anode coupled to the second end of the first transistor and a cathode coupled to the electrodes of the second group. The second path may further include: a third diode having an anode coupled to the electrodes of the second group and a cathode coupled to the first end of the first transistor; and a fourth diode having an anode coupled to the second end of the first transistor and a cathode coupled to the second end of the inductor.

### BRIEF DESCRIPTION OF THE DRAWINGS

FIG. 1 shows a schematic diagram of a plasma display device according to an exemplary embodiment of the present invention.

FIG. 2 shows a sustain discharge pulse waveform according to a first exemplary embodiment of the present invention.

FIG. 3 shows a schematic diagram of a sustain discharge circuit according to a first exemplary embodiment of the present invention.

FIG. 4 shows a signal timing diagram of a sustain discharge circuit according to a first exemplary embodiment of the present invention.

FIGS. 5A, 5B, 5C and 5D show current paths of a sustain discharge circuit of FIG. 3 operated according to signal timings of FIG. 4.

FIG. 6 shows a sustain discharge pulse according to a second exemplary embodiment of the present invention.

FIG. 7 shows schematic diagram of a sustain discharge circuit according to a second exemplary embodiment of the present invention.

### DETAILED DESCRIPTION

As used herein, the phrase “maintained at a predetermined voltage” should not be understood as “maintained exactly at a predetermined voltage”. To the contrary, even if a voltage difference between two points varies, the voltage difference is “maintained at a predetermined voltage” when the variance is within a range allowed in design constraints or when the variance is caused due to a parasitic component that is usually disregarded by a person of ordinary skill in the art. A threshold voltage of a semiconductor device (e.g., a transistor, a diode or the like) may be very low in comparison with a discharge voltage, and therefore the threshold voltage may be approximated to 0V in the following description.

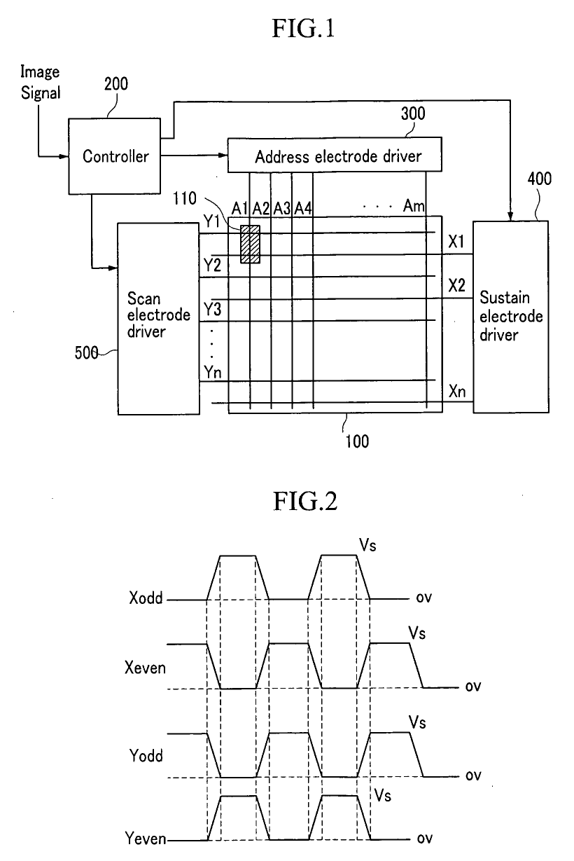

As shown in FIG. 1, the plasma display device according to the exemplary embodiment of the present invention includes a plasma display device panel (PDP) 100, a controller 200, an address electrode driver 300, a scan electrode driver 500, and a sustain electrode driver 400.

The plasma panel 100 includes a plurality of address electrodes A1-Am (hereinafter, referred to as “A electrodes”) extending in the column direction, and scan electrodes Y1-Yn (hereinafter, referred to as “Y electrodes”) and sustain electrodes X1-Xn (hereinafter, referred to as “X electrodes”) extending in the row direction. The sustain electrodes X1-Xn correspond to the scan electrodes Y1-Yn. The address electrodes A1-Am cross the scan electrodes Y1-Yn and the sustain electrodes X1-Xn. Discharge spaces are formed at regions where the address electrodes A1-Am cross the sustain and scan electrodes X1-Xn and Y1-Yn, respectively, and such discharge spaces form discharge cells 110.

The controller 200 externally receives an image signal (e.g., video image signal) and outputs driving control signals. In addition, the controller 200 controls the plasma display device by dividing a frame into a plurality of subfields having respective brightness weight values. Each subfield includes an address period and a sustain period. The address, sustain, and scan electrode drivers 300, 400, 500, respectively, receives the driving control signals from the controller 200 and applies driving voltages to the respective address electrodes A1-Am, sustain electrodes X1-Xn and scan electrodes Y1-Yn.

In more detail, during the address period of each subfield, the address, sustain, and scan electrode driver 300, 400, 500 select the turn-on and turn-off discharge cells of each subfield from among the plurality of discharge cells 110.

As shown in FIG. 2, during the sustain period of each subfield, the sustain electrode driver 400 applies a sustain pulse alternately having a high level voltage Vs and a low level voltage 0V to odd numbered sustain electrodes (hereinafter, referred to as “Xodd electrode”) among the plurality of sustain electrodes X1-Xn, and applies a sustain pulse of an inverse phase with respect to the sustain pulse of the Xodd electrodes to even numbered sustain electrodes (hereinafter, referred to as “Xeven electrode”) among the plurality of sustain electrodes X1-Xn. In addition, the scan electrode driver 500 applies a sustain pulse of an inverse phase with respect to the sustain pulse of the Xodd electrodes to odd numbered scan electrodes (hereinafter, referred to as, “Yodd electrode”) among the plurality of scan electrodes Y1-Yn, and applies a sustain pulse of inverse phases with respect to the sustain pulse of the Xeven electrodes to even numbered scan electrodes (hereinafter, referred to as “Yeven electrode”) among the plurality of scan electrodes Y1-Yn. Voltage differences between the Xodd and Yodd electrodes, and between the Xeven and the Yeven electrodes, have alternately the voltages Vs and −Vs. The voltage of the Xodd electrode overlaps the voltage of the Xeven electrode when the voltage of the Xodd electrode is rising to the voltage Vs and the voltage of the Xeven electrode is falling to 0V and vice versa, and also, the voltage of the Yodd electrode overlaps the voltage of the Yeven electrode when the voltage of the Yodd electrode is rising into the voltage Vs and the voltage of the Yeven electrode is falling to 0V and vice versa. The sustain period may be reduced by overlapping a part of the sustain pulse in such a manner.

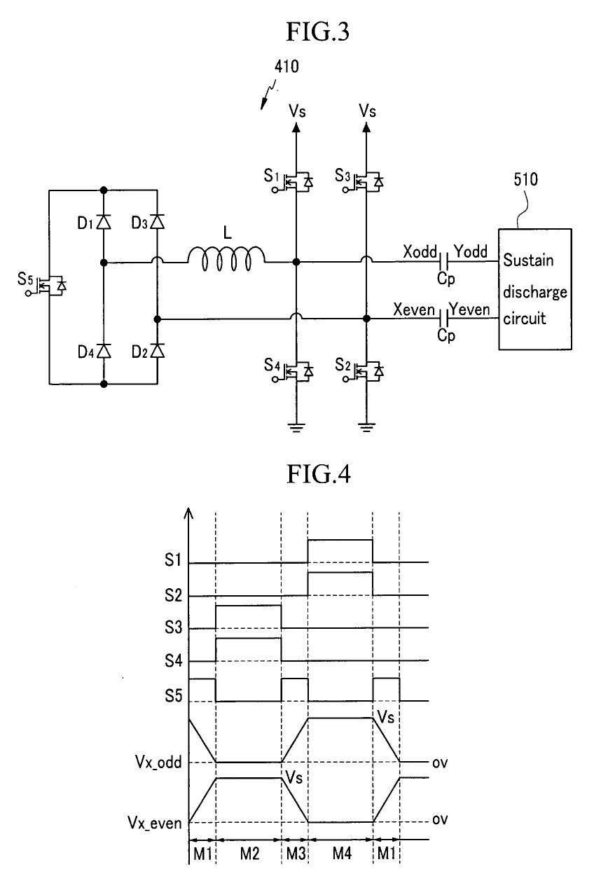

A sustain discharge circuit for supplying the sustain pulses of FIG. 2 will be described in detail with reference to FIGS. 3, 4, 5A, 5B, 5C and 5D.

FIG. 3 shows a schematic circuit diagram of a sustain discharge circuit according to a first exemplary embodiment of the present invention. For better understanding and ease of description, FIG. 3 shows only a sustain discharge circuit 410 coupled to the plurality of sustain electrodes X1-Xn. However, such a sustain discharge circuit 410 may be formed in the sustain electrode driver 400 of FIG. 1. In addition, a sustain discharge circuit 510 coupled to the plurality of scan electrodes Y1-Yn may have the same structure as the sustain discharge circuit 410 of FIG. 3, or may have different structures from the sustain discharge circuit 410 of FIG. 3.

Such a sustain discharge circuit 410 may be coupled to the Xodd and Xeven electrodes, or may be coupled to some predetermined sustain electrodes among the plurality of sustain electrodes X1-Xn. In the sustain discharge circuit 410, capacitive components formed between the Xodd and the Yodd electrodes and between the Xeven electrodes and the Yeven electrodes, for forming the discharge cells, is illustrated as a panel capacitor Cp.

As shown in FIG. 3, the sustain discharge circuit 410 according to the first exemplary embodiment of the present invention includes transistors S1, S2, S3, S4, and S5, diodes D1, D2, D3, and D4, and an inductor L. The transistors S1, S2, S3, S4, and S5 are each formed as an n-channel field effect transistor, particularly, an n-channel metal oxide semiconductor (NMOS) transistor. These transistors S1, S2, S3, S4, and S5 have a body diode formed in a direction towards a drain from a source. The transistors S1 to S5 may be formed by other transistors having similar functions. In addition, in one embodiment, the transistors S1, S2, S3, S4, and S5 shown in FIG. 3 are separately formed. Accordingly, the transistors S1, S2, S3, S4, and S5 may each be formed by a plurality of transistors coupled in parallel.

As shown in FIG. 3, a drain of the transistor S1 is coupled to a power source Vs for supplying the high level voltage Vs of the sustain pulse, and a source of the transistor S1 and a drain of the transistor S4 are coupled to the Xodd electrode. A drain of the transistor S3 is coupled to the power source Vs, a source of the transistor S3 and a drain of the transistor S2 are coupled to the Xeven electrode. The sources of the transistors S4 and S2 are coupled to a ground terminal for supplying the low level voltage of the sustain pulse, that is, the approximate ground voltage of 0V.

The inductor L has a first end coupled to the Xodd electrode and a second end coupled to an anode of the diode D1 and a cathode of the diode D4. A cathode of the diode D1 is coupled to a drain of the transistor S5, and an anode of the diode D4 is coupled to a source of the transistor S5. An anode of the diode D3 and a cathode of the diode D2 are coupled to the Xeven electrode, a cathode of the diode D3 is coupled to the drain of the transistor S5, and an anode of the diode D2 is coupled to the source of the transistor S5. When the transistor S5 is turned on, the diodes D1 and D2 form a current path from the Xodd electrode to the Xeven electrode and the diodes D3 and D4 form a current path from the Xeven electrode to the Xodd electrode.

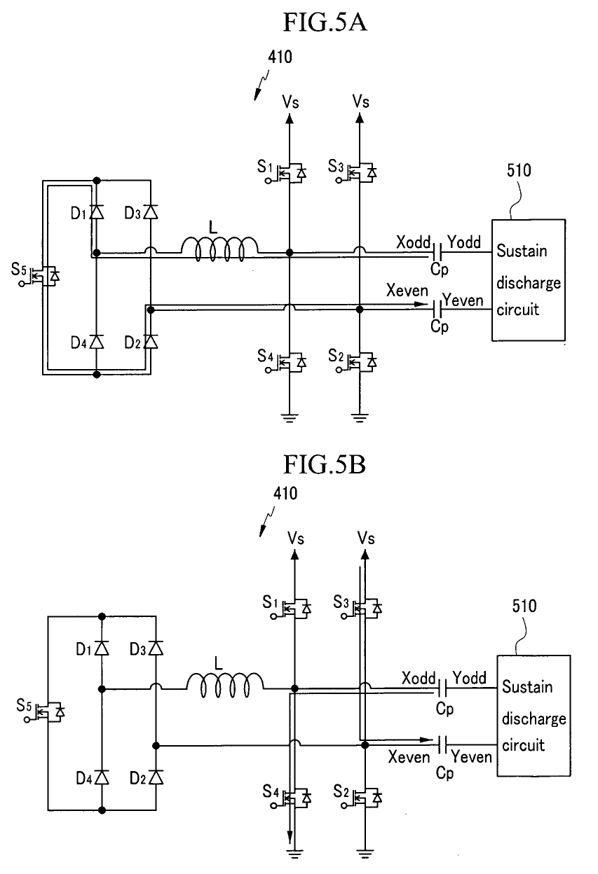

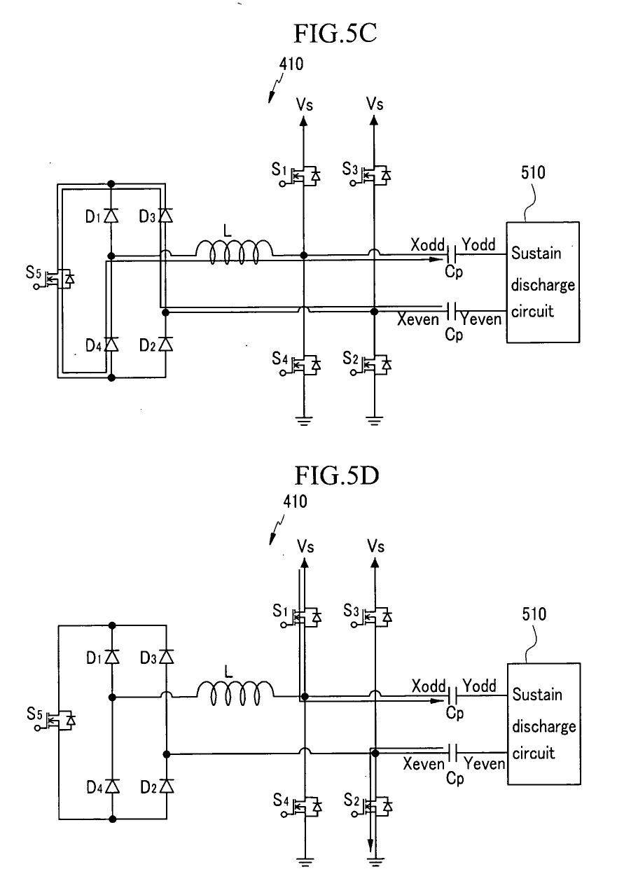

An operation of the sustain discharge circuit 410 of FIG. 3 will be described in detail with reference to FIGS. 4, 5A, 5B, 5C and 5D

FIG. 4 shows a signal timing diagram of a sustain discharge circuit according to a first exemplary embodiment of the present invention. FIGS. 5A, 5B, 5C and 5D show current paths of a sustain discharge circuit of FIG. 3 operated according to signal timings of FIG. 4.

First, it is assumed that the Xodd electrode receives the voltage Vs and the Xeven electrode receives 0V before the mode Ml starts. When the transistors S1 and S2 are turned on, the voltage Vs may be applied to the Xodd electrodes and the ground voltage 0V may be applied to the Xeven electrodes.

As shown in FIG. 4 and FIG. 5A, in the mode M1, the transistor S5 is turned on. Then, as shown in FIG. 5A, a resonance path is formed through the Xodd electrode, the inductor L, the diode D1, the transistor S5, the diode D2 and the Xeven electrode. Energy charged in the Xodd electrode is recovered through the inductor L to the Xeven electrode. Thus the voltage Vx_odd of the Xodd electrode is decreased from the voltage Vs to the ground voltage 0V and the voltage Vx_even of the Xeven electrode is increased from the ground voltage 0V to the voltage Vs. That is, energy charged in the Xodd electrode is recovered to the Xeven electrode.

In the mode M2, the transistor S5 is turned off and the transistors S3 and S4 are turned on. Then, as shown in FIG. 5B, the Xodd electrode receives the ground voltage 0V through the Xodd electrode, the transistor S4, and the ground terminal, and the Xeven electrode receives the voltage Vs through the power source Vs, the transistor S3, and the Xeven electrode.

In the mode M3, the transistors S3 and S4 are turned off and the transistor S5 is turned on. Then, as shown in FIG. 5C, a resonance is generated through the Xeven electrode, the diode D3, the transistor S5, the diode D4, the inductor L, and the Xodd electrode. Energy charged in the Xeven electrode is recovered through the inductor L to the Xodd electrode. Thus the voltage Vx_even of the Xeven electrode is decreased from the voltage Vs to the ground voltage 0V and the voltage Vx_odd of the Xodd electrode is increased from the ground voltage 0V to the voltage Vs. That is, energy charged in the Xeven electrode is again recovered to the Xodd electrode.

In the mode M4, the transistor S5 is turned off and the transistors S1 and S2 are turned on. Then, as shown in FIG. 5D, the Xodd electrode receives the voltage Vs through the power source Vs, the transistor S1, and the Xodd electrode, and the Xeven electrode receives the ground voltage 0V through the Xeven electrode, the transistor S2, and the ground terminal.

According to the first exemplary embodiment of the present invention, during the sustain period, the modes M1, M2, M3 and M4 are repeated a number of times corresponding to the weight value of the corresponding subfield. Accordingly, the Xodd electrodes and the Xeven electrodes receive a sustain pulse having different phases. In the modes M1 and M3, energy is exchanged between the Xodd and Xeven electrodes, and accordingly, additional energy recovery capacitors are not used thereby reducing the cost thereof.

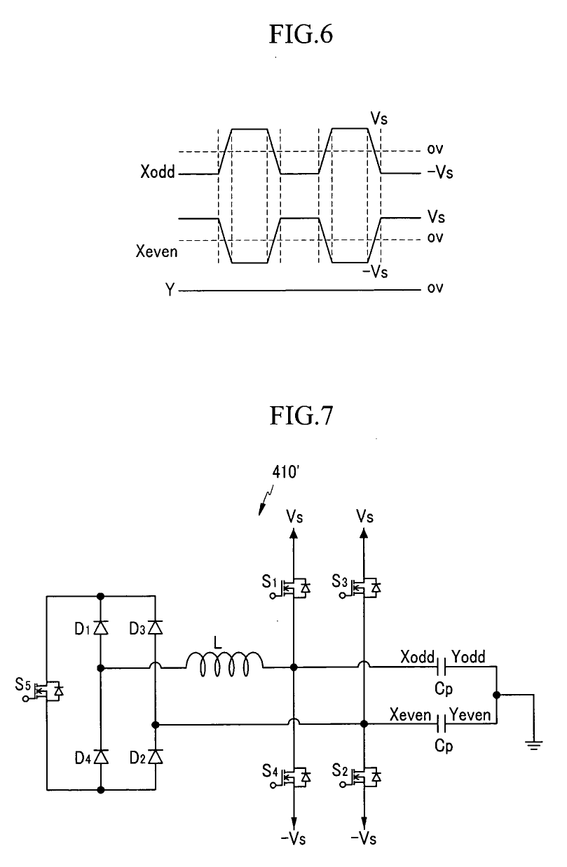

FIG. 6 shows a sustain discharge pulse waveform according to a second exemplary embodiment of the present invention. FIG. 7 shows a schematic diagram of a sustain discharge circuit according to a second exemplary embodiment of the present invention.

As shown in FIG. 6, according to the second exemplary embodiment of the present invention, during the sustain period, the Xodd electrode receives the sustain pulse having alternately the voltages Vs and −Vs, and the Xeven electrode receives the sustain pulse of inverse phases. The plurality of scan electrodes Y1 to Yn (illustrated as “Y” in FIG. 6) receives the voltage 0V. The voltage of the Xeven electrode is increased from the voltage −Vs to the voltage Vs when the voltage of the Xodd electrode is decreased from the voltage Vs to the voltage −Vs, and the voltage of the Xeven electrode is decreased from the voltage Vs to the voltage −Vs when the voltage of the Xodd electrode is increased from the voltage −Vs to the voltage Vs. In the same manner as in the sustain pulse of FIG. 2, the voltage difference between the Xodd and Yodd electrodes may alternately have the voltages Vs and −Vs, and the voltage difference between the Xeven and Yeven electrodes may alternately have the voltages Vs and −Vs.

As shown in FIG. 7, the sustain discharge circuit 410′ according to the second exemplary embodiment has the source of the transistors S2 and the source of the transistor S4 coupled to the power source −Vs having the voltage −Vs. In addition, in this case, energy may be exchanged between the Xodd electrodes and the Xeven electrodes, and accordingly, additional energy recovery capacitors need not be used.

According to the exemplary embodiment of the present invention, the cost of the sustain discharge circuit can be reduced because the additional energy recovery capacitors are not used.

It is one example that the sustain discharge circuit 410′ is coupled between the Xodd electrodes and the Xeven electrodes and the Y electrode receives approximately 0V in FIG. 6 and FIG. 7. Accordingly, the sustain discharge circuit may be coupled between the Yodd and Yeven electrodes and the X electrode may receive approximately 0V.

When the transistors S1 and S3 respectively have a drain coupled to a power source for supplying a voltage Vs/2, and the transistors S2 and S4 respectively have a drain coupled to a power source for supplying a voltage Vs/2, a sustain pulse alternately having the voltages Vs/2 and −Vs/2 may be applied. In the case, the sustain pulse alternately having the voltages Vs/2 and −Vs/2 may be applied to the Yodd electrode in an inverse phase with respect to the sustain pulse of the Xodd electrode. Also, the sustain pulse alternately having the voltages Vs/2 and −Vs/2 may be applied to the Yeven electrode in an inverse phase with the respect to the sustain pulse of the Xeven electrode.

Meanwhile, according to the exemplary embodiment of the present invention, it is one example that the plurality of sustain electrodes X1 to Xn are divided into the Xodd electrodes and the Xeven electrodes, the sustain discharge circuit is disposed between the Xodd electrodes and the Xeven electrodes, and thus energy is exchanged between the Xodd electrodes and the Xeven electrodes. Accordingly, the plurality of sustain electrodes X1 to Xn may be divided into a plurality of groups including at least one sustain electrode and the sustain discharge circuit may be disposed between the divided groups.

While this invention has been described in connection with exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plurality of electrodes, the plurality of electrodes being grouped into a first group and a second group;
a first transistor coupled between a first power source and electrodes of the first group, the first power source supplying a first voltage;
a second transistor coupled between the first power source and electrodes of the second group;
an inductor having a first end coupled to the electrodes of the first group;
a first diode having an anode coupled to a second end of the inductor;
a third transistor having a first end coupled to a cathode of the first diode;
a second diode having an anode coupled to a second end of the third transistor and a cathode coupled to the electrodes of the second group;
a third diode having an anode coupled to the electrodes of the second group and a cathode coupled to the first end of the third transistor;
a fourth diode having an anode coupled to the second end of the third transistor and a cathode coupled to the electrodes of the second group;
a fourth transistor coupled between the electrodes of the first group and a second power source for supplying a second voltage; and
a fifth transistor coupled between the electrodes of the second group and the second power source.

2. The plasma display device of claim 1, wherein the electrodes of the first group are each an odd numbered electrode and the electrodes of the second group are each an even numbered electrode.

3. The plasma display device of claim 1, further comprising:
a controller adapted to:
set the third transistor to be turned on during a first mode;
set the second transistor and the fourth transistor to be turned on during a second mode;
set the third transistor to be turned on during a third mode; and
set the first transistor and the fifth transistor to be turned on during a fourth mode.

4. The plasma display device of claim 1, wherein the second voltage is a ground voltage and the first voltage is a positive voltage.

5. The plasma display device of claim 1, wherein the first voltage is a positive voltage and the second voltage is a negative voltage.

6. A driving method of a plasma display device having a plurality of electrodes, the plurality of electrodes being grouped into a first group and a second group, the driving method comprising:
during a first mode, applying a first voltage to electrodes of the first group and applying a second voltage less than the first voltage to electrodes of the second group;
during a second mode, forming a resonance path through the electrodes of the first group, an inductor having a first end coupled to the electrodes of the first group, and a first transistor coupled between a second end of the inductor and the electrodes of the second group, and decreasing a voltage of the electrodes of the first group and increasing a voltage of the electrodes of the second group;
during a third mode, applying the second voltage to the electrodes of the first group and applying the first voltage to the electrodes of the second group; and
during a fourth mode, forming a resonance path through the electrodes of the second group, the first transistor, the inductor and the electrodes of the first group, and increasing the voltage of the electrodes of the first group and decreasing the voltage of the electrodes of the second group.

7. The driving method of claim 6, wherein during the second mode and the fourth mode, the first transistor is turned on.

8. A driving apparatus having a plurality of electrodes, the plurality of electrodes being grouped into a first group and a second group, the driving apparatus comprising:
an inductor having a first end coupled to electrodes of the first group;
a first path comprising a first transistor, wherein the first transistor is coupled between a second end of the inductor and electrodes of the second group;
a second path comprising the first transistor, wherein the first transistor is coupled between the second end of the inductor and the electrodes of the second group;
a second transistor coupled between the electrodes of the first group and a first power source for supplying a first voltage;
a third transistor coupled between the electrodes of the second group and the first power source;
a fourth transistor coupled between the electrodes of the first group and a second power source for supplying a second voltage; and
a fifth transistor coupled between the electrodes of the second group and the second power source.

9. The driving apparatus of claim 8, wherein the first path further comprises:
a first diode having an anode coupled to the second end of the inductor and an cathode coupled to the first end of the first transistor; and
a second diode having an anode coupled to the second end of the first transistor and a cathode coupled to the electrodes of the second group.

10. The driving apparatus of claim 9, wherein the second path further comprises:
a third diode having an anode coupled to the electrodes of the second group and a cathode coupled to the first end of the first transistor; and
a fourth diode having an anode coupled to the second end of the first transistor and a cathode coupled to the second end of the inductor.

11. The driving apparatus of claim 8, wherein:
the second transistor and the fifth transistor is each turned on so that the first voltage is applied to the electrodes of the first group, and the second voltage is applied to the electrodes of the second group;
the first transistor is turned on so that the voltage of the electrodes of the first group is decreased from the first voltage to the second voltage, and the voltage of the electrodes of the second group is increased from the second voltage to the first voltage;
the third transistor and the fourth transistor is each turned on so that the second voltage is applied to the electrodes of the first group and the first voltage is applied to the electrodes of the second group; and
the first transistor is turned on so that the voltage of the electrodes of the first group is increased from the second voltage to the first voltage and the voltage of the electrodes of the second group is decreased from the first voltage to the second voltage.

12. The driving apparatus of claim 11, wherein the electrodes of the first group are each an odd numbered electrode and the electrodes of the second group are each an even numbered electrode.
